(19) United States
(12) Patent Application Publication
(10) Pub. No.: US 2012/0153242 A1
(43) Pub. Date: Jun. 21, 2012

(54) INSULATION MATERIALS

(75) Inventors: Christophe Le Bonte, Molsheim (FR); Jason Walker, Lenox, MI (US)

(73) Assignee: ZEPHYROS, INC., Romeo, MI (US)

(21) Appl. No.: 13/379,401

(22) PCT Filed: Jun. 24, 2010
(86) PCT No.: PCT/EP2010/003778

§ 371 Date: Mar. 9, 2012

(30) Foreign Application Priority Data
Jun. 24, 2009 (GB) 0910923.2
Dec. 10, 2009 (GB) 0921695.3

(51) Int. Cl. E04B 1/74; C09K 21/04; C09K 21/12; C09K 21/02

(52) U.S. Cl. 252/606; 252/62; 252/609

(57) ABSTRACT

Foamable elastomeric formulations are described that are suitable for producing polymer foams with insulation and vibration damping properties and the fire retardancy required for internal aircraft panels.

The present invention relates to improvements in or relating to insulation and in particular relates to improved materials useful for providing sound insulation and/or damping to reduce the noise caused by vibration. In a preferred embodiment the invention provides a material that provides sound insulation, vibration damping and strength to a construction. The invention is further concerned with imparting flame and fire retardant properties to the insulation. The invention further provides polymer formulations useful in the production of the sound insulation and sound and vibration damping materials including such formulations having improved flame and fire retardant properties and in addition provides a flame and fire retardant system.

In motion vehicles create sound and vibration due to two activities. The simple movement of the vehicle through the surrounding atmosphere (usually air) can create sound and cause vibration. The operation of the vehicle itself usually due to the engine and associated equipment also creates sound and causes vibration. For the comfort of the occupants and also the security and safety of the vehicle it is necessary to provide materials that dampen the effect of the vibrations and provide sound insulation. This is particularly important in all types of aircraft small and large aircraft as well as helicopters. The current trend in which aircraft fuselages are being made from carbon fibre reinforced composite as opposed to the previous use of aluminium has increased the need for vibration damping and sound insulation.

There can be three (or more) forms of vibration and noise transmission in aircraft. These can be structural borne due to the aircraft itself or airborne due to the surrounding atmosphere. Vibration within the aircraft cabin causes discomfort and a safety risk. The vibration can also cause undesirable noise within the aircraft cabin and the present invention is concerned with the damping of these types of vibration and noise.

Rigorous fire regulations are imposed on materials used in the transportation industries and in particular on materials used in aircraft. Reduced flammability, fire retardancy, reduction in smoke density, low heat release on burning are important for materials that are used in transportation vehicles. In particular acoustic and damping materials that are used inside the pressurized section of the fuselage of an aircraft should comply with the requirements of the Federal Aviation Authority (FAA) tests FAR Part 25§25.853 (a) and FAR Part 25 §25.853 (d).

It is also desirable to provide these damping and reduced flammability properties with minimum addition to the weight of the vehicle or aircraft. There is therefore a need to provide a material that provides these properties with high performance to added weight ratio.

The invention is particularly useful in the production of panels useful in the interior of aircraft such as interior ceiling panels, interior wall panels, partitions, overhead bin doors, galley structures and panels. These panels can be laminar panels comprising a honeycomb structure between two facing sheets. These products are usually produced by laying up the facing sheets, a heat activated adhesive and the honeycomb structure and heating in a press, an autoclave or an oven to bond the layers together. Traditionally any acoustic damping or sound insulation has been provided by a separate layer which can be bonded to one surface of the structure or elsewhere on the fuselage structure, this however takes up additional space and requires an additional manufacturing step. Elastomers and rubber are known to provide vibration damping and sound insulation properties. However these materials are hydrocarbon based and are therefore flammable.

There is a need for sound insulation and/or vibration damping in a wide range of constructions, for example, in buildings, in aircraft, in vehicles such as automobiles, trucks and busses, in ships and in railroad vehicles. It is known to provide lightweight sound insulation by means of a honeycomb structure provided with facing sheets. It is also known that the cells of the honeycomb structure may be divided into septums in which part of the cell is provided with a sound deadening material. Vibration damping is also required in many instances, particularly with engine powered vehicles such as automobiles, aircraft, trucks and busses and railroad vehicles. It is also important in many applications that the insulating materials have good flame and fire retardancy.

It is also desirable to achieve the desired insulation and/or vibration damping with minimal weight increase. It is therefore desirable that the products provide the insulation and damping at minimum density and that formulations are available which allow this to be accomplished.

The acoustical screening power of panels such as those that are used as partition walls or aircraft cabin insulation and/or flooring material may be measured by the transmission loss (TL) usually in decibels across the panel. The higher the transmission loss the greater the sound adsorption and the better the acoustic insulation. The transmission loss will vary with the frequency of the sound with which one is concerned. The degree of vibration damping can be measured by the Structural Born Insertion Loss (SBIL) test. Flame and fire retardancy may be measured by CTA or Centre of Excellence for Airport Technology (CEAT) (approved laboratory) which submits a sample of material simultaneously to a flame (with a given gas rate) and to a radiant oven (3.5 kw/cm² was used) and measuring the total amount of calories released by 2 minutes of treatment (known as Total Heat Release in kw/m²/min) and the peak of calories released in 5 minutes (Peak Heat Release Rate in kw/m²).

Honeycomb structures are used to provide lightweight strength, however there is a problem in that in order to improve the acoustic and vibration damping properties it has been found necessary to increase the density of the structure thus resulting in an undesirable increase in the weight of the panel.

In a paper entitled “Sound Transmission Loss of Damped Honeycomb Sandwich Panels” by Portia R. Peters, Dr Shanker Rajaram and Dr Steven Nutt presented at Internoise 2006 in Honolulu 3-6 Dec. 2006, the provision of sound damping materials such as a viscoelastic layer in the mid-plane of the honeycomb structure was reported. Although this has been found to improve the acoustic properties of the structure it has proved a cumbersome and time consuming process requiring placing the viscoelastic material between two pieces of honeycomb, perhaps obtained by the transverse cutting of a honeycomb structure and securing the viscoelastic material to the two pieces of honeycomb.

Other methods that have been proposed to provide panels having improved acoustic and vibration damping properties are to provide a viscoelastic damping sheet on top of the assembled honeycomb panel. An assembled honeycomb structure typically comprises a honeycomb material sandwiched between two facing sheets. Where the panel is used for sound insulation at least one of the facing sheets is usually provided with holes or perforations to allow the sound to pass through. Where the panel is used for vibration damping this may not be necessary although if the panel is used for both sound insulation and vibration damping the presence of perforations is desirable. Each facing sheet may be what is known as a pre-preg which may be fibrous material such as glass or carbon fibre matt pre-empregnated with a curable resin such as an epoxy resin or polyurethane precursor. The honeycomb structure is assembled in a press and heated to cure the facing sheets and create a bond between the facing sheets and the honeycomb. The viscoelastic damping material may then be stuck to one or both external surfaces of the assembled structure. The process therefore involves an additional step for the gluing of the damping material to the honeycomb panel and the glue layer can be brittle and impair the damping effect of the overall structure. A further disadvantage is that the damping material adds to the weight and size of the final structure but does not contribute to the stiffness of the finished structure. In certain embodiments a further constraining layer may be applied on top of the damping material to further enhance the damping effect. Examples of materials that may be used as the constraining layer include fibre reinforced plastic, aluminium foil or thick rubber foams. Hereagain this adds to the bulk of the structure with little effect on the stiffness.

Another technique for the provision of panels providing sound insulation and vibration damping is to provide a panel having facing sheets which may be pre-pregs and a soft foamed core between the sheets. Although these panels can have good acoustic properties the foam does not contribute to the mechanical properties in the same way as a honeycomb structure at comparable weight and thickness.

Various honeycomb structures designed for acoustic insulation are described in United States Patent Publication US 2007/0134466, U.S. Pat. No. 6,267,838, U.S. Pat. No. 6,179,086, WO 2006/045723, United States Patent Publication US 200/0194210 and GB Patent Application 2252076 A.

PCT Publications WO 2006/132641 and WO 2007/050536 describe a panel structure comprising a first and second panel with a material that provides reinforcement, baffling, sealing, sound absorption, damping, alternation, thermal insulation and combinations thereof to the panel structure. The material may be a foam and the formulation of WO 2007/050536 may contain a fire retardant. These formulations are however difficult to process. In one embodiment a support for the material may be provided between the first and second panels and the support may be a honeycomb structure. It is envisaged that the support and the material which may be a foam can fill all or part of the space between the two panels. The panels may be prepared by locating the activatable material adjacent to one of the panels, placing the support such as the honeycomb against the activatable material and allowing the activatable material to expand or foam into the openings of the support.

It is known to include flame and fire retardants into polymer foams that may be used for insulation. Examples of flame and fire retardants that have been proposed include phosphorus containing compounds, metal hydrates such as magnesium or aluminium tryhydrate, various graphites including expandable graphite. The use of various combinations of retardants has also been proposed. Flame retardants tend to be solid materials of relatively high density and in order to obtain the required flame retardant properties, particularly the low heat release requirement for aircraft cabin panels, large quantities of flame retardant can be required. This adds undesirable additional weight to the vibration damping and sound insulation system. Furthermore such large amounts tend to increase the melt viscosity of the formulation reducing its processability and leading to undesirable pressure build up in an extruder particularly when producing thin strips of material that can be required for the production of sound insulation and vibration damping in panels

The use of the formulation of the present invention allows the production of a panel with fire retardant properties having acoustic damping or sound insulation material embedded therein without the need to modify existing manufacturing techniques. The ability to provide the acoustic damping and sound insulation material embedded within the panel saves space in the construction of the vehicle.

The present invention addresses these issues and provides a formulation that can be used to provide vibration damping and/or sound insulation, that has reduced flammability and in particular complies with the FAA tests FAR Part 25§25.853 (a) and FAR Part 25§25.853 (d) with minimal weight increase. Furthermore the invention provides a formulation that can be used to impart vibration damping and/or sound insulation to panels without significant modification of the processes currently used for panel manufacture.

In one embodiment the present invention provides improved formulations useful in providing, acoustic insulation and/or vibration damping, improved fire resistant properties such as flame retardancy, reduced burn time, reduced smoke density and reduced heat release which is of light weight and which can be used in panels to provide vibration damping in vehicles with minimal space requirements and which can be employed in conventional panel manufacturing processes.

The present invention therefore provides a foamable formulation for use in the production of vibration damping materials having improved fire resistant properties comprising

i) an elastomer
ii) a plasticiser
iii) a blowing system
iv) a fire retardant system

The plasticiser may also act as an adhesion promoter and in this instance is preferably an adhesion promoting resin, the blowing system is preferably a blowing agent and the fire retardant is, inter alia, a flame retardant.

The plasticiser improves the processability of the formulation. In panel manufacture for aircraft a thin strip of foamable material is required typically a strip of thickness less than 2 millimetres more typically of a thickness in the range of 0.5 to 1.5 millimetres. The width of the strip with depend upon the type and size of the panel although typical widths range from 100 to 500 millimetres more typically 200 to 350 millimetres. Extrusion of a formulation with no plasticiser results in an undesirable pressure build up at the extrusion die. Whilst any suitable plasticiser can be used we have found that the use of a polymeric plasticiser such as a liquid polybutene can provide further vibration damping and sound insulation, can also act as an adhesion promoter and can improve the processability of the formulation. As with the elastomer these materials are flammable and their use increases the need for fire retardants. Supplementary plasticizers may also be included and we particularly prefer to use fire retardant plasticizers such as the phosphate based plasticizers such as the Santicizer range of phosphate based plasticizers as a supplementary plasticiser.

It is preferred that the elastomer be cross linkable and that the formulation contains a cross linking agent for the cross linkable elastomer so that once foamed it can be cross-linked to preserve the integrity of the cell structure and avoid collapse. It is also preferred that when the formulation is heated to cause foaming the cross linkable elastomer cross links in addition to foaming.

In a further embodiment of the invention the foamable elastomer is such that when it heated to cause foaming, the material develops adhesive properties.

In discussing the formulations of the present invention percentages refer to weight percent, unless otherwise indicated.

Foamable materials of the present invention will include a substantial amount of an elastomeric material, which can be one elastomer or a mixture of several different elastomers. The elastomeric material is typically at least about 5%, more typically at least 10% preferably at least about 14%, even more typically at least 25% by weight of the foamable material and the elastomeric material is typically less than about 65%, more typically less than about 60% by weight and most typically less than 40% by weight of the foamable material.

Elastomers suitable for the elastomeric material include, without limitation, natural rubber, styrene-butadiene rubber, polyisoprene, polyisobutylene, polybutadiene, isoprene-butadiene copolymer, neoprene, nitrile rubber (e.g. a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene monomer rubbers), chlorosulphonated polyethylene, fluorinated hydrocarbons and the like. Particularly preferred elastomers are EPDMs sold under the tradename VISTALON 7800 and 2504, commercially available from Exxon Mobil Chemical and butyl rubbers sold under the Exxpro tradename by Exxon Mobil Chemical. Other preferred elastomers are polybutene isobutylene copolymer sold under the tradename H-1500, commercially available from BP Amoco Chemicals. A preferred elastomer is a copolymer of an iso-olefin and an alkyl styrene such as a C₄-C₇ iso-olefins and a C₁-C₅ alkyl styrene particularly preferred are halogenated copolymers particularly brominated copolymers of isobutylene and paramethyl styrene such as the Exxpro materials supplied by Exxon Mobil Chemical. However, for certain uses such as in aircraft it is preferred that the elastomer be halogen free. We prefer to use a rubber having a high vibration loss factor and here butyl rubber is preferred, such as the rubbers available from Exxon Mobil Chemical or Lanxess may be used. Exxpro 3433 and Lanxess 402 are particularly useful. Mixtures of these elastomers may also be used and in some instances are preferred.

The foamable material contains a blowing system which typically comprises one or more blowing agents. The blowing system may be a physical blowing agent and/or a chemical blowing agent. For example, the blowing agent may be a thermoplastic encapsulated solvent that expands upon exposure to a condition such as heat. Alternatively, or in addition the blowing agent may chemically react to liberate gas upon exposure to a condition such as heat or humidity or upon exposure to another chemical reactant.

The blowing agent may include one or more nitrogen containing groups such as amides, amines and the like. Examples of suitable blowing agents include azodicarbonamide, dinitrosopentamethylenetetramine, 4,4ᵢ-oxy-bis-(benzenesulphonylhydrazide), trihydrazinotriazine and N,Nᵢ-dimethyl-N,Nᵢ-dinitrosoterephthalamide.

We prefer to use a blowing system comprising a mixture of a chemical blowing agent and a physical blowing agent such as an encapsulated solvent because although the physical blowing agent has good expansion properties it can increase the flammability of the product due to the presence of alkanes and hence it is preferred to use the combination.

An accelerator for the chemical blowing agents may also be provided. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles, ureas or the like.

The amounts of blowing agents and blowing agent accelerators that should be used can vary depending upon the type of cellular structure desired, the desired amount of expansion of the foamable material and the desired rate of expansion. Exemplary ranges for the amounts of blowing agents and blowing agent accelerators in the foamable material range from about 0.001% by weight to about 5% by weight of the elastomeric material. In the preferred formulation we prefer that the blowing agent comprise from 10% to 60% by weight of a chemical blowing agent and from 90% to 40% weight of a physical blowing agent. For the production of vibration damping a degree of expansion of from 200% to 1000% is preferred, more preferably 300 to 500%. It is also preferred that the expansion occur at a temperature in the range 120° C.-180° C. in from 10 to 180 minutes, preferably 120° C. to 160° C. more preferably 120° C.-140° C. and that expansion is complete in less than 15 minutes.

One or more curing or cross linking agents and/or curing agent accelerators may be included in the foamable material. Amounts of curing agents and curing agent accelerators can, like the blowing agents, vary widely depending upon the type of cellular structure desired, the desired amount of expansion of the activatable material, the desired rate of expansion and the desired structural properties of the foamed material. Exemplary ranges for the curing agents or curing agent accelerators that may be used in the material range from about 0.001% by weight to about 7% by weight of the elastomeric material. In particular the curing or cross linking agents will be present when the elastomeric material is cross linkable. In one embodiment butyl rubber together with a cross-linking agent is used.

When the elastomeric material employed in the formulation is cross linkable a cross linking agent may be included and they may be selected from aliphatic or aromatic amines or their respective adducts, amidoamines, polyamides, cycloaliphatic amines, (e.g. anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), sulfur or mixtures thereof. Particular preferred curing agents include modified and unmodified polyamines or polyamides such as triethylenetetramine, diethylenetriamine tetraethylenepentamine, cyanoguanidine, dicyandiamides and the like. An accelerator for the curing agents (e.g. a modified or unmodified urea such as methylene diphenyl bis urea, an imidazole or a combination thereof) may also be provided. Other example of curing agent accelerators include, without limitation, metal carbamates (e.g. copper dimethyl dithio carbamate, zinc dibutyl dithio carbamate, combinations thereof or the like), disulfides (e.g. dibenzothiazole disulfide). Metal salts may also be used and when using the preferred brominated copolymer of isobutylene and paramethyl styrene as the cross-linkable elastomer it is preferred to use zinc salts such as zinc oxide and/or zinc stearate as the cross-linking agent. When the formulations are used to provide vibration damping and/or sound insulation embedded in a panel comprising pre-preg facing sheets it is preferred to use a curing agent that will interact with the pre-preg materials during curing to improve the adhesion between the foam and the pre-pregs. Similarly if the panel has a honeycomb inter layer the curing agent in the foamable formulation may be selected to react with the honeycomb to further improve adhesion.

Though longer curing times are also possible, curing times of less than 5 minutes, and even less than 30 seconds are possible for the cross linkable formulation of the present invention. Moreover, such curing times can depend upon whether additional energy (e.g. heat, light, radiation) is applied to the material or whether the material is cured at room temperature.

As suggested, faster curing agents and/or accelerators can be particularly desirable for shortening the time between onset of cure and substantially full cure (i.e. at least 90% of possible cure for the particular activatable material) and curing the foamed material while it maintains its self supporting characteristics. As used herein, onset of cure is used to mean at least 3% but no greater than 10% of substantially full cure. For the embodiment of the present invention where the elastomeric material is cross linkable, it is generally desirable for the time between onset of cure and substantially full cure to be less than about 30 minutes, more typically less than about 10 minutes and even more typically less than about 5 minutes and still more typically less than one minute. It should be noted that more closely correlating the time of softening of the elastomeric materials, the time of curing and the time of bubble formation or blowing can assist in allowing for foaming of the expandable material without substantial loss of its self supporting characteristics.

Also as suggested previously, the foamable material can be formulated to include a curing agent that at least partially cures the foamable material prior to foaming of the material. Preferably, the partial cure alone or in combination with other characteristics or ingredients of the foamable material imparts sufficient self supporting characteristics to the material such that, during foaming, the foamable material, expands volumetrically without significantly losing shape or without significant flow under gravity.

In one embodiment, the foamable material includes a first curing agent and, optionally, a first curing agent accelerator and a second curing agent and, optionally, a second curing agent accelerator, all of which are preferably latent. The first curing agent and/or accelerator are designed to partially cure the foamable material during processing (e.g. processing, mixing, shaping or a combination thereof) of the foamable material for at least assisting in providing the material with the desirable self supporting properties. The second curing agent and/or accelerator will be such that they cure the foaming and foamed material upon exposure to a condition such as heat, moisture or the like.

As one preferred example of this embodiment, the second curing agent and/or accelerator are such that they cure the elastomeric materials of the foamable material at a second temperature or temperature range. The first curing agent and/or accelerator are also latent and they partially cure the expandable material upon exposure to a first elevated temperature that is below the second temperature.

The first temperature and partial cure can be experienced during material compounding, shaping or both. For example, the first temperature and partial cure can be experienced in an extruder that is mixing the ingredients of the foamable material and extruding the foamable material through a die into a particular shape. As another example, the first temperature and partial cure can be experienced in a molding machine (e.g. injection molding, blow molding compression moulding) that is shaping and, optionally, mixing the ingredients of the foamable material.

Partial cure can be accomplished by a variety of techniques. For example, the first curing agent and/or accelerator may be added to the foamable material in sub-stoichiometric amounts such that the polymeric material provides substantially more reaction sites than are actually reacted by the first curing agent and/or accelerator. Preferred sub-stoichiometric amounts of first curing agent and/or accelerator typically cause the reaction of no more than 60%, no more than 40% or no more than 30%, 25% or even 15% of the available reaction sites provided by the polymeric material. Alternatively, partial cure may be effected by providing a first curing agent and/or accelerator that is only reactive for a percentage of the polymeric material such as when multiple different polymeric materials are provided and the first curing agent and/or accelerator is only reactive with one or a subset of the polymeric materials. In such an embodiment, the first curing agent and/or accelerator is typically reactive with no more than 60%, no more than 40% or no more than 30%, 25% or even 15% by weight of the polymeric materials.

Like the previous embodiments, the partial cure, alone or in combination with other characteristics or ingredients of the activatable material, imparts sufficient self supporting characteristics to the activatable material such that, during activation and/or foaming, the activatable material, doesn't experience substantial flow in the direction of gravity.

Also like the previous embodiments, partial cure, upon mixing may be effected by a variety of techniques. For example, the first curing agent and/or accelerator may, upon mixing of the first component and second component, be present within the foamable material in sub-stoichiometric amounts such that the elastomeric material[s] provide substantially more reaction sites than are actually reacted by the first curing agent and/or accelerator. Preferred sub-stoichiometric amounts of first curing agent and/or accelerator typically cause the reaction of no more than 60%, no more than 40% or no more than 30%, 25% or even 15% of the available reaction sites provided by the material. Alternatively, partial cure may be effected by providing a first curing agent and/or accelerator that is only reactive for a percentage of the material such as when multiple different materials are provided and the first curing agent and/or accelerator is only reactive with one or a subset of the materials. In such an embodiment, the first curing agent and/or accelerator is typically capable of reaction with no more than 60%, no more than 40% or no more than 30%, 25% or even 15% by weight of the material.

The foamable material of the present invention includes one or more fire retardants. The choice of the fire retardant will depend upon the use envisaged for the formulation and the fire related specifications and requirements associated with that use. Where the foamed material is required to satisfy fire, smoke and toxicity tests a range of fire retardants may be used and useful fire retardants include, halogenated polymers, other halogenated materials, materials (e.g. polymers) including phosphorous, bromine, chlorine, oxide and combinations thereof. Exemplary flame retardants include, without limitation, chloroalkyl phosphate, dimethyl methylphosphonate, bromine-phosphorus compounds, ammonium polyphosphate, neopentylbromide polyether, brominated polyether, antimony oxide, calcium metaborate, chlorinated paraffin, brominated toluene, hexabromobenzene, antimony trioxide, graphite (e.g. expandable graphite), combinations thereof or the like. Other flame retardants that may be used include tricresyl phosphate and aluminium trihydrate.

The invention further provides a formulation with reduced heat release containing a particular fire retardant combination. Certain uses such as internal panels in aircraft have more stringent requirements particularly in terms of heat release and we have found that formulations containing a heat expandable graphite can reduce heat release.

Heat expandable graphite is known as a fire retardant from for example United States in U.S. Pat. Nos. 3,574,644 and 5,650,448 which describes its use in polymer foams for aircraft seating. PCT publication WO 2005/101976 suggests that it may be used together with nitrogen containing fire retardants optionally together with a metal hydroxide in an amount of 25-50 wt % as a phosphorous fire retardant in olefin containing polymers.

Examples of phosphorus containing fire retardants that may be used include red phosphorus, ammonium phosphates such as polyphosphates, melamine phosphates or pyrophosphate. The metal oxide, hydroxide or hydrate fire retardant may be any know metal containing fire retardant. Preferred materials include aluminium tri-hydrate and magnesium hydroxide.

It is preferred that the fire or flame retardant be halogen free. In order to obtain the desired flame retardant properties it may be necessary to include up to 75 wt % based on the weight of the formulation of the flame retardant. Preferred formulations contain from 60 wt % to 75 wt % of the flame retardant. The preferred flame retardant system depends upon the use to which the formulation is to be put. However, in the preferred use to provide vibration damping and sound insulation in aircraft, particularly an embedded foamed material within a panel such as a panel containing a honeycomb inner layer where heat release is an important factor we have found that a three component fire or flame retardant system is particularly useful the present invention therefore further provides the use of a fire retardant formulation comprising:
i) a phosphorus containing fire retardant
ii) a metal oxide, hydroxide or hydrate fire retardant
iii) graphite

The preferred fire retardant formulation in the formulation of the present invention.
a) from 20% to 60% by weight of a phosphorus containing fire retardant
b) from 5% to 25% by weight of a metal oxide, hydroxide or hydrate fire retardant
c) from 5% to 25% by weight of graphite.

The present invention further relates to improvements to the flame and fire retardant systems themselves and their use particularly to impart flame and fire resistance to sound insulation and/or damping materials.

The present invention therefore further provides a fire retardant system comprising:
iv) a phosphorus containing fire retardant
v) a metal oxide, hydroxide or hydrate fire retardant
vi) graphite

The preferred fire retardant system of the invention comprises
d) from 20% to 60% by weight of a phosphorus containing fire retardant
e) from 5% to 25% by weight of a metal oxide, hydroxide or hydrate fire retardant
f) from 5% to 25% by weight of graphite

The phosphorous containing fire retardant provides a barrier against flame propagation, ammonium polyphosphate is preferred. The metal oxide, hydroxide or hydrocarbon absorbs heat as it contains water however it should not be used in large quantities as it can increase the smoke density. The graphite used is preferably heat expandable graphite (HEG) which expands in response to heat to produce a fire barrier. The expandable graphite may be any of those well-known in the art, such as those described by Titelman, G. I., Gelman, V. N., Isaev, Yu. V and Novikov, Yu. N., in Material Science Forum, Vols. 91-93, 213-218, (1992) and in U.S. Pat. No. 6,017,987.

The heat expandable graphite decomposes thermally under fire into a char of expanded graphite, providing a thermally insulating barrier, which resists further oxidation.

The heat expandable graphite is derived from natural graphite or artificial graphite, and upon rapid heating from room temperature to high temperature it expands in the c-axis direction of the crystal (by a process so-called exfoliation or expansion). In addition to expanding in the c-axis direction of the crystal, the heat expandable graphite expands a little in the a-axis and the b-axis directions as well. The exfoliation degree or the expandability of HEG depends on the rate of removing the volatile compounds during rapid heating. The expandability value in the present invention relates to the ratio of the specific volume obtained following rapid heating to a temperature of 500-700 C, to the specific volume at room temperature. A specific volume change of HEG in the present invention is preferably not less than 50 times for that range of temperature change (room temperature to 500-700 C). Such an expandability is preferred because a HEG having a specific volume increase by at least 50 times during rapid heating from room temperature to 700 C, has been found to produce a much higher degree of fire retardancy compared to a graphite that is heat expandable but has a specific volume increase of less than 50 times in the aforesaid heating conditions.

During rapid heating of HEG from room temperature to high temperature such as 700 C, a weight loss is usually recorded. 10% to 35% (preferably 15% to 32%) weight loss of HEG is usually due to volatile compounds removed in the aforesaid heating conditions at the volume expandability of 50 times and more. A HEG grade having a weight loss of less than 10%, during rapid heating, provides a specific volume increase of less than 50 times. A HEG grade having a weight loss of more than 35%, during rapid heating, provides less amount of a char of expanded graphite, and consequently the fire retardancy may be achieved only at higher loading of HEG.

The carbon content of heat expandable graphite that exhibits under aforesaid heating conditions a volume expandability of 50 times or higher, should be 65% to 87% (preferably 67.5% to 85%) by weight for serving as a good carbonaceous barrier and for providing a high level of fire retardancy in combination with N-containing flame-retardants.

The HEG having a carbon content of more than 87%, provides during rapid heating a specific volume increase of less than 50 times. Decreasing the carbon content in HEG to less than 65% under the aforesaid heating conditions, provides less amount of a char of expanded graphite, and consequently the fire retardancy of the polymer composition may be achieved only at higher loading of HEG.

During rapid heating of HEG from room temperature to a rather lower temperature (such as about 500 C) a specific volume change of HEG should be more than 50 and less than 100 times. A HEG grade having a too-high specific volume increase at a rather lower temperature (such as about 500 C) provides too fast expansion of HEG under burning and consequently the fire retardancy may be achieved only at higher loading of HEG.

The heat expandable graphite used in the present invention can be produced in different processes and the choice of the process is not critical. It can be obtained, for example, by an oxidation treatment of natural graphite or artificial graphite. The oxidation is conducted, for example, by treatment with an oxidizing agent such as hydrogen peroxide, nitric acid or another oxidizing agent in sulphuric acid. Common conventional methods are described in U.S. Pat. No. 3,404,061, or in U.S. Pat. Nos. 1,657,473 and 1,657,474. Also, the graphite can be anodically oxidized in an aqueous acidic or aqueous salt electrolyte as described in U.S. Pat. No. 4,350,576. In practice, most commercial grades of the heat expandable graphite are usually manufactured via an acidic technology.

The heat expandable graphite, which is produced by oxidation in sulphuric acid or a similar process as described above, can be slightly acidic depending on the process conditions. When the heat expandable graphite is acidic, a corrosion of the apparatus for production of the polymeric composition may occur. For preventing such corrosion heat expandable graphite should be neutralized with a basic material (alkaline substance, ammonium hydroxide, etc.).

The particle size of the heat expandable graphite used in the present invention affects the expandability degree of the HEG and, in turn, the fire retardancy of the resulting polymer composition.

The heat expandable graphite of a preferred particle size distribution contains up to 25%, more preferably from 1% to 25%, by weight particles passing through a 75-mesh sieve. The HEG containing more than 25% by weight particles passing through a 75-mesh sieve may not provide the required increase in specific volume and consequently, may not provide the sufficient fire retardancy. The heat expandable graphite containing the above particles at a content which is lower than 1% by weight may slightly impair the mechanical properties of the resulting polymer composition. The dimensions of the largest particles of HEG, beyond 75-mesh, should be as known in the art in order to avoid the deterioration of the properties of the polymer composition. In a preferred embodiment, the surface of the heat expandable graphite particles may be surface-treated with a coupling agent such as a silane-coupling agent, or a titanate-coupling agent in order to reduce the adverse effects of larger particles on the properties of the fire-retarded polymer composition. A coupling agent can be separately added to the composition as well.

The fire retardant can be a fairly substantial weight percentage of the foamable material. The fire retardant[s] can comprise greater than 2%, more typically greater than 12%, even more typically greater than 25% and even possibly greater than 35% by weight of the foamable material. When a brominated copolymer of isobutylene and paramethyl styrene is used as the elastomer, we prefer to use from 40% to 75% more preferably 40-60% by weight of a fire retardant based on the weight of the formulation, and in particular we prefer to use a compound derived from ammonium phosphate such as ammonium polyphosphate and zinc borate optionally containing aluminium trihydrate. When the foamable elastomer is butyl rubber we prefer to use from 40% to 75% of the preferred fire retardant composition of the invention.

The foamable materials of the present invention can include an adhesion promoter, which may be one or a mixture of multiple components. The adhesion promoter may be a liquid or a solid or a combination of the two and is preferably a material that develops adhesive properties at the temperature at which the foamable material foams. When used, the adhesion promoter is typically present at least about 1%, more typically at least about 4%, even more typically at least 8% by weight of the foamable material formulation typically 10% to 20% by weight of the formulation. Various adhesion promoters can be employed such as epoxy containing materials, polyacrylates, hydrocarbon resins and terpene resins. One particularly preferred adhesion promoter is a hydrocarbon resin sold under the tradename SUPER NEVTAC 99, commercially available from Neville Chemical Company. Another particularly preferred adhesion promoter is liquid polybutene which may be used with a butyl rubber elastomer and which, in addition acts as a plasticiser or a processing aid. A preferred adhesion promoter comprises a blend of a terpene resin and a polybutene preferably a liquid polybutene such as Indopol H300.

The formulation contains a processing aid or plasticiser to improve the processing of the formulation at elevated temperatures such as those experienced in extrusion or injection molding. Low molecular weight ethylene containing polymers are particularly suitable. Ethylene/ester copolymers or terpolymers such as ethylene/vinyl ester copolymers and ethylene/acrylate esters are preferred which may, optionally, be modified with additional monomers. We have found that the introduction of up to 10% more typically 3 to 7 wt % of such polymers based on the weight of the formulation can be beneficial. Low molecular weight elastomers such as Indopol H300 may also function as such processing aids or plasticisers.

The foamable material may also include one or more fillers, including but not limited to particulate materials (e.g. powder), beads and microspheres. Preferably, the filler includes a relatively low-density material that is generally non-reactive with the other components present in the foamable material.

Examples of fillers that may be used include silica, diatomaceous earth, glass, clay, talc, pigments, colorants, glass beads or bubbles, glass, carbon ceramic fibers, antioxidants, and the like. Such fillers, particularly clays, can assist the material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular improved the impact resistance of the cured and foamed material.

When employed, the fillers in the foamable material can range from 10% to 90% by weight of the foamable material. According to some embodiments, the foamable material may include from about 0.001% to about 30% by weight, and more preferably about 10% to about 20% by weight clays or similar fillers. Powdered (e.g. about 0.01 to about 50, and more preferably about 1 to 25 micron mean particle diameter) mineral type filler can comprise between about 5% and 70% by weight, more preferably about 10% to about 20%, and still more preferably approximately 13% by weight of the foamable material.

It is contemplated that one of the fillers or other components of the material may be thixotropic for assisting in controlling flow of the material as well as properties such as tensile, compressive or shear strength. Such thixotropic fillers can additionally provide self supporting characteristics to the activatable material. Examples of thixotropic fillers include, without limitation, silica, calcium carbonate, clays, aramid fiber or pulp or others. One preferred thixotropic filler is synthetic amorphous precipitated silicon dioxide.

Other additives, agents or performance modifiers may also be included in the foamable material as desired, including but not limited to an antioxidant, an antistatic agent, a UV resistant agent, an impact modifier, a heat stabilizer, a UV photoinitiator, a colorant, a processing aid, a lubricant, a reinforcement (e.g. chopped or continuous glass, ceramic, aramid, or carbon fiber or the like).

The foamable materials of the present invention may include processing oil, which may be one or a mixture of multiple oils. One particularly preferred processing oil is a refined petroleum oil sold under the tradename SENTRY 320, commercially available from Citgo oil. When used such oils can be present in the foamable material from about 1% to about 25% by weight, but may be used in higher or lower quantities.

The invention further provides use of an optionally halogenated copolymer of an iso olefin and an alkyl styrene as the cross-linkable and foamable elastomeric material in acoustic panels comprising two facing panels separated by a honeycomb structure containing a foamed cross-linked elastomeric material within the cells of the honeycomb structure. The iso-olefine is preferably a C₄-C₇ iso-olefine and the alkyl styrene is a C₁-C₅ alkyl styrene, the halogen may be fluorine, chlorine or bromine with bromine being preferred. A brominated copolymer of isobutylene and paramethyl styrene is preferred. As previously described in certain applications such as use in aircraft, it is preferred that the elastomer be halogen free.

The invention further provides such a use together with a plasticiser which may also act as an adhesion promoter. Liquid polybutene is preferred.

In yet a further embodiment the invention provides such a use together with a fire retardant preferably comprising a compound derived from ammonium phosphate or polyphosphate and zinc borate optionally containing aluminium trihydrate.

As described the foamed and optionally halogenated copolymers of iso-olefins and an alkyl styrene have been found to be particularly useful in the provision of sound insulation and/or vibration damping. Typically the copolymers contain from 2 to 8 moles of the alkyl styrene per 100 moles of the iso-olefin and from 20 to 50 wt % of the halogen based on the weight of the alkyl styrenes. These materials are available from Exxon Mobil Chemical Company under the Exxpro trade name and they are described in U.S. Pat. Nos. 5,162,445; 5,430,118; 5,426,167; 5,548,023; 5,548,029; 5,654,379. The iso-olefin is preferably isobutylene and the alkyl styrene may be ortho, meta or para alkyl styrene with para alkyl styrene being preferred. The alkyl group may be C₁ to C₅ alkyl and methyl is preferred, the preferred alkyl styrene being para methyl styrene. The halogen may be chlorine, bromine or fluorine with bromine being preferred.

The invention therefore further provides a formulation comprising an optionally halogenated copolymer of an iso-olefin and an alkyl styrene and a blowing agent. The blowing agent maybe a physical and/or chemical blowing agent and is preferably present in an amount up to 5 wt % based on the weight of the copolymer and may be present together with a blowing agent activator.

In a further embodiment the formulation contains a flame retardant and the invention therefore provides a formulation comprising an optionally halogenated copolymer of an iso-olefin and an alkyl styrene, a blowing agent and a flame retardant. The blowing agent is preferably present in an amount up to 5 wt % based on the weight of the copolymer and may be present together with a blowing agent activator. The flame retardant may be any of the materials previously described and the amount should be selected according to the properties required although we prefer that the formulation contain from 20 to 75 wt % more preferably 20 to 70 wt % most preferably 30 to 50 wt % of the flame retardant.

In a further embodiment the formulation also includes an adhesion promoter such as those previously described. The adhesion promoter may be solid or liquid, it imparts adhesion to the formulation and preferably develops adhesive properties at the temperature at which the foamable material foams. The adhesion promoter can also act as a plasticiser or processing aid for the formulation.

The invention therefore further provides a formulation comprising

i) an optionally halogenated copolymer of an iso-olefin and an alkyl styrene
ii) a blowing system
iii) a fire retardant system
iv) a plasticiser

In a further embodiment the formulation also contains a cross-linking agent which causes the halogenated copolymers of an iso-olefin and an alkyl styrene to cross-link at elevated temperature.

The invention therefore further provides
i) an optionally halogenated copolymer of an iso-olefin and an alkyl styrene
ii) a blowing system
iii) a fire retardant system
iv) a plasticiser
v) a cross-linking agent for the halogenated copolymer of an iso-olefin and an alkyl styrene.

The cross-linking agent may be any of those materials previously mentioned and is preferably present in an amount of from 0.1% to 5% by weight of the optionally halogenated copolymer of an iso-olefin and an alkyl styrene.

A preferred formulation of the invention therefore comprises
i) from 10% to 60 wt % based on the weight of the formulation of a copolymer of an iso-olefin and an alkyl styrene
ii) from 0.1 to 5 wt % based on the weight of the copolymer of a blowing system
iii) from 25% to 50 wt % based on the weight of the formulation of a fire retardant system
iv) from 1 to 10 wt % based on the weight of the formulation of plasticiser.
v) from 0.1 to 5 wt % based on the weight of the copolymer of a cross-linking agent

The invention further provides use of a foamable rubber with a high damping loss factor such as butyl rubber in acoustic panels comprising two facing panels separated by a honeycomb structure containing a foamed cross-linked rubber with a high damping loss factor such as butyl rubber within the cells of the honeycomb structure. The formulation preferably contains from 10 to 60 wt % more preferably 25 to 60 wt % of butyl rubber.

The invention further provides such a use together with a plasticizer which may also act as an adhesion promoter. Liquid polybutene is preferred. More preferably polybutene and a terpenic resin.

In yet a further embodiment the invention provides such a use together with a fire retardant preferably comprising a three component system comprising an ammonium phosphate, a metal oxide, hydroxide or hydrate and expandable graphite.

In a further embodiment the invention therefore provides a formulation comprising a rubber with a high damping loss factor such as butyl rubber, a blowing system and a flame retardant system. The blowing system may be a chemical and/or a physical blowing agent and is preferably present in an amount up to 5 wt % based on the weight of the rubber such as butyl rubber and may be present together with a blowing agent activator. The flame retardant system may be any of the materials previously described and the amount should be selected according to the properties required although we prefer that the formulation contain from 20 to 70 wt % more preferably 30 to 50 wt % of the flame retardant system.

The invention therefore further provides a formulation comprising

i) a rubber with a high damping loss factor
ii) a blowing system
iii) a fire retardant system
iv) a plasticiser

The high damping rubber is preferably butyl rubber

In a further embodiment the formulation also contains a cross-linking agent which causes the butyl rubber to cross-link at elevated temperature.

The invention therefore further provides

i) butyl rubber
ii) a blowing system
iii) a fire retardant system
iv) a plasticiser
v) a cross-linking agent

The cross-linking agent may be any of those materials previously mentioned and is preferably present in an amount of from 0.1% to 5% by weight of the rubber typically butyl rubber.

A preferred formulation of the invention therefore comprises
i) from 10% to 60 wt % based on the weight of the formulation of a rubber with a high damping loss factor such as butyl rubber.
ii) from 0.1 to 5 wt % based on the weight of the copolymer of a blowing system
iii) from 25% to 70 wt % based on the weight of the formulation of a fire retardant system
iv) optionally from 1 to 20 wt % based on the weight of the formulation of a plasticiser or processing aid.
v) optionally from 0.1 to 5 wt % based on the weight of the copolymer of a cross-linking agent.

In a preferred embodiment the formulation comprises
i) an elastomer
ii) a blowing system comprising a mixture of a physical and chemical blowing agent
iii) at least 50 wt % of a fire retardant system
iv) a polymeric processing aid
v) a cross linking agent for the elastomer
vi) a fire retardant
vii) optionally an adhesion promoter
   the polymeric processing aid and the adhesion promoter may be the same material.

The invention further provides the use of these formulations to provide foam insulation and or vibration damping materials including materials having flame retardant properties that satisfy the requirements for internal components of aircraft. Particularly foam that may be provided within a honeycomb structure. We have found that these formulations can provide foams having desirable insulation and damping properties with an expansion of up to 1000% typically up to 500% and at a density below 0.20 grams/cc, even below 0.17 grams/cc.

The formulation may contain other additives such as those previously described.

In a preferred embodiment the plasticiser is also an adhesion promoter such as liquid polyisobutylene and is thus part of an elastomer blend.

In a further embodiment the formulation is employed to provide a foam in a panel comprising two facing panels separated by a honeycomb structure wherein the cells of the honeycomb structure contain foam derived from the foamable elastomeric material of the present invention which adheres to at least one of the facing panels and the walls of the cells of the honeycomb structure. The foamed elastomeric material may fill part of/all of the cells of the honeycomb structure and adhere to both the facing panels. It is preferred that the foamed elastomeric material is cross linked.

In a preferred panel one or both of the facing panels are “pre-pregs”. Where the panels are used for sound insulation it is preferred that at least one of the facing panels is provided with holes or perforations to allow the sound to pass into the honeycomb cell structure. Where the panels are used for vibration damping the holes or perforations may not be required although if the panel is to perform both functions, holes or perforations are preferred. The holes or perforations may be provided in one or both of the facing panels and where they are in only one that should be the side facing, the source of the sound. Pre-preg is an abbreviation for pre-impregnation and a pre-preg consists of a combination of a matrix and fibre reinforcement; the combination can be supplied as a sheet which can be cured to a rigid high strength, low weight sheet by the action of heat. It is therefore preferred that the pre-preg and the foamable material used in the present invention are selected so that the heating causes the foaming and adhesion to occur simultaneously with the curing of the pre-preg. In this way the panels of the present invention may be produced in a simple one step heating process without the need for additional processing steps and the use of other adhesives. Examples of suitable pre-pregs that may be used include glass, carbon or textile fibre containing epoxy resin, phenolic resin or polyurethane precursor matrices. Hegply products supplied by Hexcel and SP Products supplied by Gurit are particularly useful. Components such as cross-linking agents may be included in the formulation which will react with components in the pre-preg as it cures to form a bond between the foam and the facing panel.

The honeycomb structures will be selected according to the requirements of the panel. Honeycombs are available in different thicknesses, cell sizes and density and are also available in a wide range of materials such as paper, metals, plastics and the like.

The essence of one embodiment of the invention is therefore that by appropriate selection of the foamable elastomeric material and the quantity employed the (at least) four component structure of two facing panels, a honeycomb dividing layer and an at least partially filling foamed flame retardant elastomeric sound absorbing and/or vibration damping layer embedded in the panel can be produced in a single operation rather than by the prior multi-stage operations. Furthermore, by adjusting the formulation the panel can be produced employing the manufacturing equipment and conditions such as temperature pressure and time previously employed for the production of foam free panels. In addition, the performance of the panel both in terms of acoustic insulation and vibration damping as well as rigidity can be tailored by adjusting the formulation to obtain the degree of foaming and cross-linking required for the desired performance.

In a preferred process such a panel structure may be formed by applying a layer of the foamable elastomeric material directly to the first facing panel, thereafter, the material is activated to soften, expand, optionally cure or a combination thereof to wet and adhere the material to the walls of the cells of the honeycomb and the first or both of the panels. The presence of the plasticiser facilitates the production of the layer and also enhances the foaming.

Once assembled typically automatically, manually, or a combination thereof, the foamable material is activated to soften, expand and optionally develop adhesive properties so that the expanded foamable material provides vibration dampening, sound absorption or a combination thereof together with fire retardancy to the panel and serves to bond the components of the panel together.

In a preferred embodiment the foamable material is formulated to expand and cure at the temperature at which the assembly is heated in a panel press. In such a process the assembled panel structure is fed to a panel press where it experiences temperatures that are typically above about 65° C., more typically above about 100° C. and even more typically above about 130° C. and below about 300° C., more typically below about 220° C. and even more typically below about 175° C. Such exposure is typically for a time period of at least about 10 minutes, more typically at least about 30 minutes and even more typically at least about 60 minutes and less than about 360 minutes more typically less than about 180 minutes and even more typically less than about 90 minutes. While in the press, a pressure is typically applied to the panel structure urging the components of the structure toward each other.

Alternative manufacturing techniques may be used such as vacuum forming and baking, or autoclaving typically with the application of pressure.

Panels containing foam derived from the formulation of the invention may be used in several different articles of manufacture such as transportation vehicles (e.g. automotive vehicles, railroad vehicles, buildings, furniture or the like). The panels can be used to provide the required vibration and acoustic damping combined with fire and flame retardancy without the need for additional materials or layers to provide these properties. Typically, although not required, the panel structure is employed for forming the interior of one of these articles of manufacture. In such an embodiment, at least one of the facing panels of the panel structure is exposed to and/or at least partially defines an inner open area of the article while the other facing panel of the panel structure is closer to a body of the article. For example, in a building, the inner or first panel would be exposed to and/or define the interior of a room of the building while the outer or second panel would be closer to the outer building material (e.g. brick, siding or the like) of the building. As another example, in an automotive vehicle such as an aircraft, the inner or first panel would be exposed to and/or at least partially define an interior cabin of the vehicle while the outer or second panel would be closer to the body of the vehicle.

The panel structures are particularly useful in aircraft where they can be used in several locations within the interior of an aircraft. For example, the panel may form part or the entirety of a door, an overhead storage compartment, a side panel, an archway, a ceiling panel or combinations thereof and can be used in the main cabin, crew rest compartments, partitions walls, galleys, lavatories and in the cockpit. The panel may also be employed in an airplane wing, or in the floor structure of the cabin of the aircraft. When the structure is employed within an airplane the first or inner panel will typically be exposed and/or at least partially define the interior cabin of the airplane. Of course, the panels may be reversed. Moreover, the panel may be located away from the fuselage and may or may not be exposed to the interior cabin of the plane. For example, the panel may be completely enclosed (e.g. within an interior door of a plane) or may be covered with carpet (e.g. as in a floor panel of a plane). It should be understood that the facing panel that is closest to the interior cabin may be covered by an aesthetic covering such as paint, wallpaper, a plastic fascia, cloth, leather or combinations thereof and may still define the interior cabin. The panel structure may be strategically located for reducing sound transmission and/or vibration into an aircraft. Often an airplane includes one or more openings (e.g. through-holes, interface locations or the like) which can provide sound and/or fluid communication between an internal portion of the airplanes and the external environment surrounding the airplane. Thus, it is contemplated that a panel structure can be placed adjacent or overlaying such openings for promoting sound reduction (e.g. sound absorption, sound attenuation or both).

In the panels the foamed elastomeric material may fill a portion, a substantial portion or substantially the entirety of the volume of the cells of the honeycomb structure between two panels. The amount of the volume filled may depend upon considerations such as desired strength, desired sound absorption and desired vibration damping.

The foamable material may be applied using a variety of techniques such as extrusion and manual location of the material. In one embodiment, the material may be applied from an applicator (e.g. an extruder). In such an embodiment, the applicator may be moved relative to surface to which it is to be supplied such as the one or more panels and/or the support, vice versa or a combination thereof. It may be desirable for the applicator to be substantially entirely automated, but may also include some manual components as well. The plasticisers aids in the application of the foamable material. Exemplary systems of these applicators are disclosed in U.S. Pat. No. 5,358,397 and European Patent Application Publication No. 1131080.

When using an applicator such as the extruder, it can be desirable to elevate the temperature of the foamable material to a temperature at which it flows but below that at which it foams to assist the material in adhering to a substrate such as a first panel. Upon cooling, the material is unfoamed and is preferably substantially tack free to the touch. Alternatively the materials may be only slightly tacky so as to allow handling of the materials without any substantial portions of the material being removed due to the handling.

In another embodiment, a layer of the foamable material may be manually or automatically applied first to a substrate such as a panel using instruments and/or the hands of the individual. Generally, one or more masses of the foamable material are manually applied according to one of the aforementioned protocols.

In one particular embodiment, one singular mass or multiple masses in the form of strips of foamable material are pressed against the first facing panel and the honeycomb structure such that the strips attach because of the adhesive properties of the foamable material, deformation of the material upon pressing or both. It is also contemplated that the strips of material may be contoured (e.g. bent) about contours of the one or more panels and or the honeycomb (particularly the outer edge of the honeycomb) during pressing or manual application. In such an embodiment, it is typically desirable for the strip[s] of foamable material to be sufficiently flexible to allow bending of the strip[s] from a first straight or linear condition or shape to a second angled or arced condition or shape (e.g. such that one portion of the strip is at an angle a right angle) relative to another portion) without significant tearing or cracking of the strip (e.g., tearing or cracking that destroy the continuity of the strip or pull one part of the strip away from another part). The use of the plasticiser in the formulation of the invention aids in the extrusion of the thinner strips required in this embodiment.

Advantageously, the foamable material may be such that the material can be quite easily shaped prior to activation. As such, the material can be more easily applied in a variety of locations. As one example, the material may be pressed and/or pushed into the cells of the honeycomb.

The present invention is illustrated by the following Examples in which Transmission Loss and Structural Born Insertion Loss and flame and fire retardancy tests were performed on various honeycomb containing panels.

The Transmission Loss measurement was in accordance with ISO 15186-1:2000 and satisfactory results were obtained.

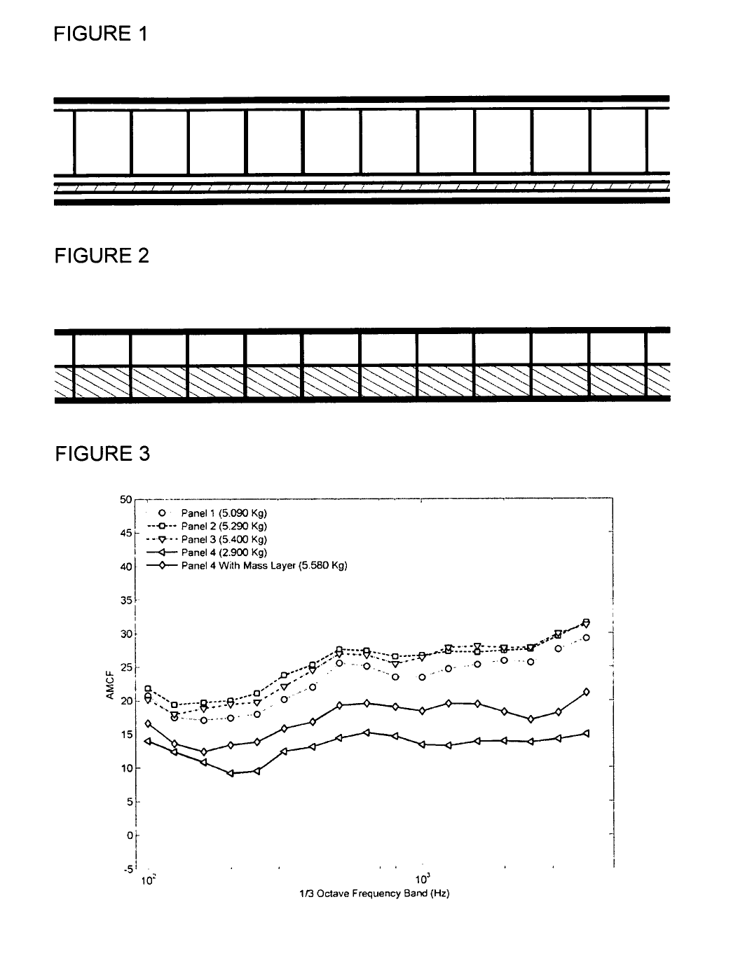

The panels tested were prepared by constructing the multilayer assembly shown in FIG. 1 from the following materials.

The panels were made of an honeycomb core of 9.4 mm thick, NOMEX material (fiberglass pre-impregnated paper), cell size of 3.2 mm and overall density of 29 kg/m3, and facing panels made from pre-pregs the outer pre-preg was from ISOVOLTA brand, reference AIRPREG 2050/T0F1 and the inner pre-preg was also from ISOVOLTA brand with reference AIRPREG PY8150.

Panel 4 was made for comparative purposes and was made only from the honeycomb and the facing panels. Panels 1, 2 and 3 were the same except a layer of a foamable, cross-linkable elastomeric material of the invention was put in the press on the inner pre-preg side before heating. The foamable cross-linkable elastomeric material had the following formulation
i) 40 wt % brominated copolymer of isobutylene and paramethyl styrene (EXXPRO 3443)
ii) 2 wt % of a mixture of zinc oxide and zinc stearate as a cross-linking agent for the brominated copolymer of isobutylene and paramethyl styrene
iii) 10 wt % liquid polybutene
iv) a blowing agent system comprising 4 wt % azodicarbonamide and 0.5 wt % of an amine based activator of azodicarbonide
vii) balance a compound derived from ammonium phosphate and zinc borate as a flame retardant
   the components were blended and extruded to provide the layer of foamable material used in the press.

The thickness of the layer of foamable material before expansion was 1.2 mm and after expansion about 5 mm, so filling half the height of the cells of the honeycomb. The degree of expansion of the material was 400-500%. FIG. 2 is a cross section of panel 1 showing the foam inside the honeycomb and efficiently stuck to the cells boundaries. Panels 1, 2 and 3 are intended to be identical and the slight weight discrepancies reflect minor process variations.

Panel 5 is also comparative, it has no interior foam and is panel 4 provided with an external damping layer of material attached to the panel by self adhesive bands. The damping layer used was of 0.7 mm thickness and two layers of this material were glued together and stuck to the outer pre-preg to give a total thickness of 1.4-1.5 mm.

The panels were produced in the following presses.

a) For the large panels (1000×1500 mm)

Press manufacturer: Langzauner

Plate size: 1350×2750 mm

Controlling: piloted by computer (Touchscreen): by pressure

Temperature: piloted by computer: heating and cooling system (max 2-3° C./min),

b) For the smaller panels (250×250 mm)

Press manufacturer: Langzauner

Plate size: 1000×1300 mm

Same controlling than large press,

Temperature: up to 400° C. (fast heating and cooling system (10° C./min).

### EXAMPLE 1

The following cycle was employed in the large panel press to produce foam containing panels 1, 2, 3 and 4.
a first curing cycle with the foamable cross-linkable material and the honeycomb without the pre-preg
cool down the whole panel in the press
open and the press and introduce the pre-pregs and heat the assembly for a further 30 minutes at 155° C.
allow to cool from 155° C. to 50° C. over a period of one hour.

### EXAMPLE 2

In the large panel press the temperature was increased from 50° C. to 155° C. over 30 minutes and held at 155° C. for a further 30 minutes. It was then cooled down to 50° C. to produce panel 5.

### EXAMPLE 3

Employed the smaller panel press 0.5 mm thick patches of the foamable cross-linkable material were laid on the honeycomb and the curing cycle employed in Example 2 was used to produce panel 6.

The panels were cut to provide samples for testing using a cutting table from Altendorf (model F45) with a blade provided with diamant edge at a cutting speed of 4000 rpm. FIG. 2 is a cross sectional view of a panel according to the invention.

Structure Born Insertion Loss measurements provide information concerning the ability of the panel to limit the noise generated by virtue of vibrations in the environment in which the panel is used and are based on a comparison of the radiated power and the mechanical input power. The ratio of radiated power to mechanical input power is a measure of “Acoustical-Mechanical Conversion Factor” of the panel, referred to by AMCF.

The difference of AMCF of two different panels of comparable structure will lead to the Structure-Borne Insertion Loss (SBIL) which is a measure of the amount of sound insulation one can expect from the addition of a sound damping component to an undamped structure.

The AMCF calculation is performed using the following expression:

$$A M C F = 10 {log}_{10} ( \frac{{P}_{inj}}{{P}_{rad}} )$$

where Pᵢₙⱼ is the power injected mechanically to the structure and P_{rad} is the radiated power.

The SBIL calculation is thus performed using the following expression:

$$S B I L = 10 {{log}_{10} ( \frac{{P}_{inj}}{{P}_{rad}} )}_{Treated Sample} - 10 {{log}_{10} ( \begin{matrix}{P}_{inj} \\ {P}_{rad}\end{matrix} )}_{Untreated Sample}$$

Mechanical input power is measured using an impedance head while the radiated power is measured using an acoustic intensity probe. The input power is measured for 3 different shaker locations on the panel and is calculated using the following expression:

$${P}_{inj} = \frac{1}{2} Re ( 〈 {FV}^{*} 〉 )$$

with [symbol] V* [symbol] the averaged cross-spectrum between force and velocity at the input location. The averaging is performed over time and frequency.

The radiated power is acquired, for each shaker location, by measuring the intensity over the anechoic side of the panel.

For each shaker location, the radiated power is measured in ⅓ octave bands using an intensity probe with quarter-inch microphones and 6 mm spacer to cover the frequency range of 100 Hz to 10 kHz. The radiated power is calculated using the following expression:

P_{rad}= [symbol] I [symbol] *Area

with [symbol] I [symbol] the averaged sound intensity.

The intensity measurement is done following the standard previously described for transmission loss measurements.

The structures are installed between the reverberant room and the anechoic room. Since a reverberation room is on the shaker side of the panel, additional absorption material was provided in the room to prevent coupling with the acoustic response of the room.

The panel is excited with a shaker supported by bungee cables. An impedance head is installed on the panel with glue. From one shaker location to the other, the impedance head is removed and glued to the next location. The impedance head is glued at the exact same locations when testing the five panels.

Vibration measurements are also performed on the panel. Accelerometers are used to get the space averaged quadratic mobility and Damping loss factor using the decay rate method over the panel's surface. The same locations are used for all the panels.

The tests were performed using 3 different shaker locations in order to get the modal contribution from the most possible modes (spatial average on the force location).

The space averaged quadratic mobility (velocity over force) is determined using 5 accelerometers moved to six different locations on the panel. All signals are referenced to the impedance head force transducer. The vibration measurements are done by time averaging over a 20 second period. The excitation signal is then shut down to measure the accelerometers decaying signals. The decaying signals are then post-processed using an in-house Matlab code to calculate the damping loss factor using the Decay Rate Method.

As for transmission loss testing, SBIL measurements require an intensity probes but also need an impedance head for mechanical input power measurements. Each transducer were calibrated prior to measurements as follows

| Transducer | Model | Serial number | Sensitivity | Units |
|---|---|---|---|---|
| Intensity probe Ch. A | 4197 | 2277880 | 3.65 | mV/Pa |
| Intensity probe Ch. B | 4197 | 2277880 | 3.45 | mV/Pa |
| Impedance head force | 288D01 | 2395 | 22.19 | mV/N |
| transducer | | | | |
| Impedance head | 288D01 | 2395 | 10.01 | mV/m/s² |
| Accelerometer | | | | |
| Accelerometer 1 | 4397A | 10747 | 1.01 | mV/m/s² |
| Accelerometer 2 | 4397A | 10745 | 1.00 | mV/m/s² |
| Accelerometer 3 | 4397A | 10258 | 1.01 | mV/m/s² |
| Accelerometer 4 | 4397A | 10835 | 0.99 | mV/m/s² |
| Accelerometer 5 | 4397A | 10838 | 1.00 | mV/m/s² |

The panels that were tested for the transmission loss were also tested for Structure Born Insertion Loss.

### Results

FIG. 3 plots the measured AMCF for the five panels. The results are presented in ⅓ octave bands from 100 Hz to 4000 Hz (the frequency is on a logarithmic scale).

The detailed results are set out in Table 2.

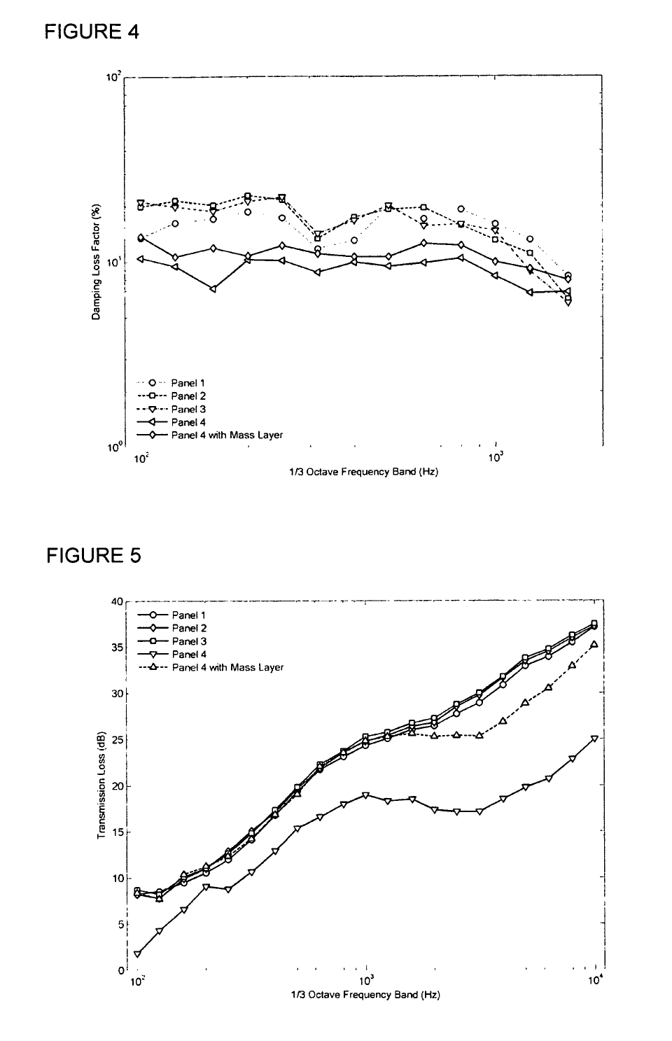

FIG. 4 gives the measured Darning Loss Factor (DLF) for the tested panels. The results are limited to 1.6 kHz because of the difficulty to input appropriate power to the structure at high frequency and the high damping of the panels. Note that even for panels 4 and 5 (panel 4 with mass layer) there is always extra damping added by mounting in the test window, above 1600 Hz, the panels are too damped and the accelerometers signals are too low to get reliable results.

FIG. 5 shows the transmission loss for the five panels.

TABLE 2
AMCF results for all configurations tested (dB).

| Frequency (Hz) | Panel 1 | Panel 2 | Panel 3 | Panel 4 | Panel 5 |
|---|---|---|---|---|---|
| 100 | 20.8 | 21.8 | 20.2 | 14.0 | 16.6 |
| 125 | 17.5 | 19.4 | 18.0 | 12.4 | 13.6 |
| 160 | 17.1 | 19.8 | 18.8 | 10.9 | 12.4 |
| 200 | 17.5 | 20.0 | 19.5 | 9.2 | 13.4 |
| 250 | 18.0 | 21.1 | 19.7 | 9.5 | 13.9 |
| 315 | 20.2 | 23.8 | 22.1 | 12.4 | 15.8 |
| 400 | 22.0 | 25.3 | 24.5 | 13.1 | 16.8 |
| 500 | 25.5 | 27.6 | 27.0 | 14.4 | 19.3 |
| 630 | 25.1 | 27.4 | 26.7 | 15.2 | 19.5 |
| 800 | 23.5 | 26.5 | 25.4 | 14.6 | 19.0 |
| 1000 | 23.4 | 26.7 | 26.3 | 13.4 | 18.4 |
| 1250 | 24.7 | 27.3 | 27.8 | 13.2 | 19.5 |
| 1600 | 25.3 | 27.2 | 28.0 | 13.9 | 19.4 |
| 2000 | 25.9 | 27.4 | 27.8 | 13.9 | 18.2 |
| 2500 | 25.6 | 27.6 | 27.8 | 13.8 | 17.1 |
| 3150 | 27.6 | 29.6 | 29.9 | 14.2 | 18.1 |
| 4000 | 29.2 | 31.6 | 31.2 | 15.0 | 21.1 |

### EXAMPLE 4

Flame and fire retardancy tests were performed employing the following formulation.

| | |
|---|---|
| Butyl rubber (Exxpro 402 from Exxon Mobil Chemical) | 20% |
| Indopol H300 | 17% |
| Phenolic resin | 3% |
| 4,4,-oxy-bio (benzenesulphonyl hydrazide | 2% |
| Expandable microspheres | 2% |
| Expandable graphite | 15% |
| Aluminium Trihydrate | 13% |
| Ammonia Polyphosphate | 28% |

The material was used to produce foam containing panels by the same method as Example 1.

The foam produced was found to have an expanded density of from 0.15-0.17 and to have acceptable insulation and damping properties with a Tan delta of from 0.35 to 0.45.

### EXAMPLES 5 TO 7

The following formulations were employed to produce panels in a similar manner to the production of panel 1. The parts are percent by weight of the formulation.

| | Example | | |
|---|---|---|---|
| | 5 | 6 | 7 |
| Expro 3433 | 22 | | |
| Bromobutyl rubber | | 25 | |
| Butyl rubber No 2 | | | 10 |
| Indopol H300 | 15 | 5 | 13 |
| 4,4,-oxy-bio benzene | 2 | 1.5 | 1.5 |
| sulphonyl hydrazide | | | |
| Expandable microspheres | 3 | 1.5 | |
| Expandable graphite | 15 | 20 | 20 |
| Aluminium trihydrate | 13 | 15 | 18 |
| Ammoniun polyphosphate | 30 | 29 | 33.5 |
| Supplementary plasticiser | | 3 | 2 |
| (santicizer) | | | |
| Phenolic resin (SP1045) | | | 1 |
| Unicell | | | 1 |

The Indopol H300 acted as both a plasticiser and an adhesion promoter.

The panels had comparable Transmission Loss and Structural Born Insertion Loss Performance to panels 1, 2 and 3.

FAR Part 25§25.853 (a) and FAR Part 25§25.853 (d).

Sections of the panels were subjected to the FAA Heat Release and Heat Release Rate tests (FAR Part 25§25.853 (d)) applicable to the interior of pressurised aircraft cabins and were found to pass as in both tests the heat did not exceed 65 Kw min/m². A foam prepared from each of the formulations was subjected to the FAA Fire Smoke and Toxicity test (FAR Part 25§25.853 (a)) and all were found to comply with the requirements that
i. the burn length did not exceed 152 mm
ii. the flame time does not exceed 15 seconds
and
iii. the smoke density does not exceed 150.

1: A foamable formulation for use in the production of vibration damping materials having improved fire resistant properties comprising i) an elastomer ii) a plasticiser or processing aid iii) a blowing system iv) a flame retardant system.

2: A formulation according to claim 1 containing an adhesion promoter.

3: A formulation according to claim 1, wherein the plasticiser and the adhesion promoter are the same material.

4: A foamable formulation according to claim 1, wherein the elastomer is cross linkable and containing a cross linking agent for the elastomer.

5: A formulation according to claim 1, wherein the elastomer is present in an amount of from 5% to 65% weight of the foamable material.

6: A formulation according to claim 1, wherein the elastomer is halogen free.

7: A formulation according to claim 1, wherein the elastomer is a rubber with a high damping loss factor.

8: A formulation according to claim 1, wherein the elastomer is a butyl rubber.

9: A formulation according to claim 1, wherein the elastomer is cross linkable and is an optionally halogenated copolymer of an iso-olefin and an alkyl styrene such as a C₄-C₇ iso-olefine and a C₁-C₅ alkyl styrene particularly preferred are brominated copolymers of isobutylene and paramethyl styrene.

10: A formulation according to claim 1 containing from 0.1% by weight to 5% by weight of the blowing system based on the weight of the formulation.

11: A formulation according to claim 1 containing from 25 to 70% by weight of the fire retardant system based on the weight of the formulation.

12: A formulation according to claim 1 containing from 1 to 20 wt % of the plasticiser.

13: A formulation according to claim 12, wherein the plasticiser is liquid polybutene.

14: A formulation according to claim 1 containing a supplementary plasticiser.

15: A formulation according to claim 14, wherein the supplementary plasticiser is a fire retardant plasticiser.

16: A formulation according to claim 1, wherein the fire retardant comprises a mixture of i) a phosphorous containing fire retardant ii) a metal oxide, hydroxide or hydroxide fire retardant iii) graphite.

17: A formulation according to claim 16, wherein the graphite is heat expandable graphite.

18: A formulation according to claim 1, wherein the blowing system is a mixture of a physical and a chemical blowing agent.

19: A formulation according to claim 1, wherein the blowing system, and the cross-linking agent perform their respective functions at a temperature in the range 100° C. to 180° C.

20: A formulation according to claim 1 comprising i) from 10% to 60 wt % based on the weight of the formulation of an elastomer, ii) from 0.1 to 5 wt % based on the weight of the formulation of a blowing system iii) from 25% to 75 wt % based on the weight of the formulation of a fire retardant system iv) from 1 to 20 wt % based on the weight of the formulation of a plasticiser or processing aid. v) from 0.1 to 5 wt % based on the weight of the copolymer of a cross-linking agent.

21: A fire retardant formulation comprising: i) a phosphorus containing fire retardant ii) a metal oxide, hydroxide or hydrate fire retardant iii) graphite.

22: A fire retardant formulation according to claim 21 comprising: a) from 20% to 60% by weight of a phosphorus containing fire retardant b) from 5% to 25% by weight of a metal oxide, hydroxide or hydrate fire retardant c) from 5% to 25% by weight of graphite.

23: A fire retardant composition according to claim 21, wherein the phosphorus containing fire retardants are selected from red phosphorus, ammonium phosphates such as polyphosphates, melamine phosphates or pyrophosphate.

24: A fire retardant according to claim 21, wherein the metal oxide or hydroxide is aluminium tri-hydrate or magnesium hydroxide.

25: A fire retardant according to claim 21, wherein the graphite used is heat expandable graphite (HEG).
